(19) United States
(12) Patent Application Publication
(10) Pub. No.: US 2007/0140772 A1
(43) Pub. Date: Jun. 21, 2007

(54) Torque coupling

(75) Inventor: Louis C. Barinaga, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/305,639

(22) Filed: Dec. 16, 2005

(51) Int. Cl. B41J 23/00

(52) U.S. Cl. 400/636.2

(57) ABSTRACT

Various embodiments and methods pertaining to torque coupling are disclosed.

### BACKGROUND

Transmissions may be used to selectively transmit power or torque to different recipients for different uses. Improper relative positioning of components of the transmission during shifting between power recipients may result in shifting failures and may result in damage to the shifting components.

### BRIEF DESCRIPTION OF THE DRAWINGS

FIG. 1 is a schematic illustration of one example of a transmission transmitting torque to a first torque recipient according to one example embodiment.

FIG. 2 is a schematic illustration of the transmission of FIG. 1 disengaged from the first torque recipient according to an example embodiment.

FIG. 3 is a schematic illustration of the transmission of FIG. 1 rotated and moved to transmit torque to a second torque recipient according to an example embodiment.

FIG. 4 is a top perspective view of one example of a printer including one embodiment of the transmission of FIGS. 1-3 according to an example embodiment.

FIG. 5 is a sectional view of the transmission of FIG. 4 taken along line 5-5 with additional components schematically shown according to an example embodiment.

FIG. 5A is an enlarged fragmentary view of the transmission of FIG. 5 taken along line 5A-5A according to an example embodiment.

FIG. 6 illustrates the transmission of FIG. 5 in a disengaged state according to an example embodiment.

FIG. 7 illustrates the transmission of FIG. 6 in a disengaged and angularly repositioned state according to an example embodiment.

### DETAILED DESCRIPTION OF EXAMPLE EMBODIMENTS

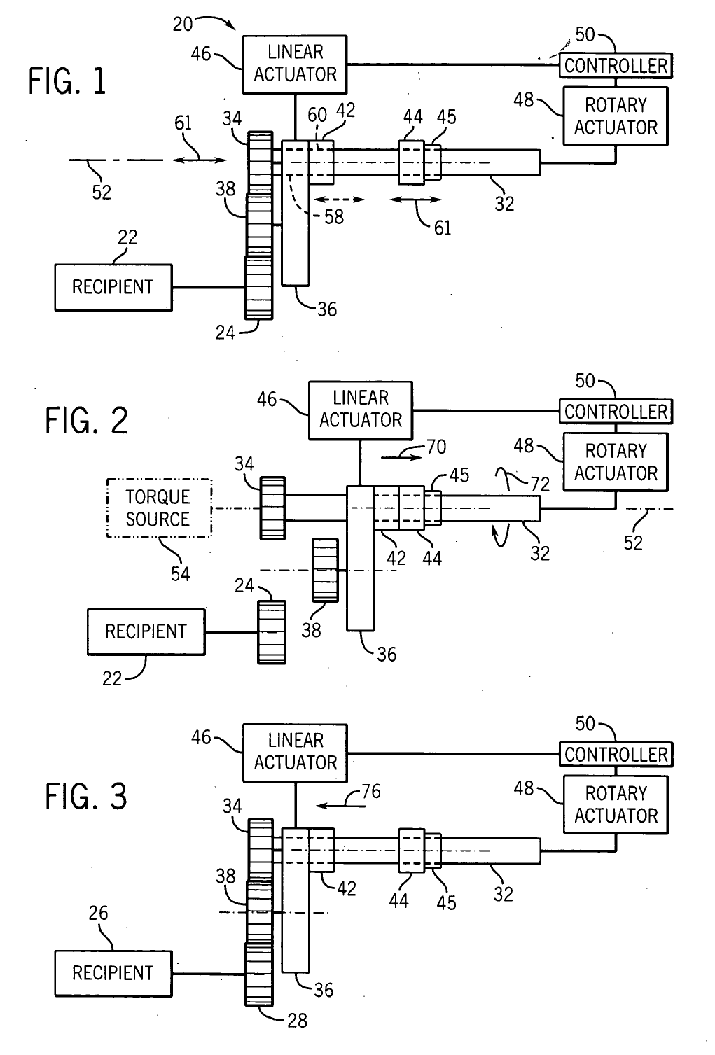

FIG. 1 schematically illustrates one example of transmission 20 configured to selectively transmit torque to one of multiple potential recipients. In the particular embodiment illustrated, transmission 20 is configured to selectively transmit torque to a first torque recipient 22 operably coupled to an associated gear 24 or a second torque recipient 26 operably coupled to an associated gear 28. Recipients 22 and 26 (shown in FIG. 3) may comprise any one of a multitude of mechanisms or devices that may utilize torque to mechanically move or actuate one or more structures or components. Recipients 22 and 26 are operably connected to gears 24 and 28 either directly or by an intervening drive train.

Transmission 20 generally includes shaft 32, drive gear 34, swing arm 36, coupling gear 38, torque coupling portion 42, torque coupling portion 44 (sometimes referred to as a synchronizer), bias 45, linear actuator 46, rotary actuator 48 and controller 50. Shaft 32 extends along axis 52 and is configured to be rotatably driven about axis 52 by rotary actuator 48 so as to rotate torque coupling portion 44. When torque coupling portion 44 is engaged with torque coupling portion 42, rotation of portion 44 further rotates swing arm 36 and gear 38 to reposition gear 38 with respect to a gear of a desired torque recipient such as gear 24 or gear 28.

Drive gear 34 comprises a gear configured to transmit torque from a torque source to coupling gear 38 which further transmits the torque to a gear associated with a torque recipient. In the particular example illustrated, drive gear 34 is coupled to shaft 32 which is rotatably driven by rotary actuator 48 which serves as a source of torque. In other embodiments, drive gear 34 may alternatively be separate or rotatable with respect to shaft 32, wherein drive gear 34 is rotatably driven by an alternative torque source such as torque source 54 schematically shown in phantom in FIG. 2.

Swing arm 36 comprises an elongate structure linearly movable along axis 52 while carrying or supporting coupling gear 38. Swing arm 36 includes an internal bore 58 through which shaft 32 extends into connection with drive gear 34. Bore 58 permits shaft 32 to be rotatably driven about axis 52 so as to also rotate gear 34 while swing arm 36 remains substantially stationary.

Coupling gear 38 comprises a pinion gear rotatably supported by swing arm 36. Coupling gear 38 is configured to be moved into and out of intermeshing engagement with gear 24 and either gear 24 or gear 28 so as to enable transmission 20 to selectively transmit torque from rotary actuator 48, through shaft 32, through gears 34 and 38, and through one of gears 24 or 28 to recipient 22 or recipient 26 (shown in FIG. 3).

Torque coupling portion 42 comprises a mechanism non-rotatably connected to swing arm 36 such that rotation of coupling portion 42 also results in rotation of swing arm 36. In the particular example illustrated, torque coupling portion 42 includes an internal bore 60 through which shaft 32 extends, allowing shaft 32 to rotate about axis 52 without corresponding rotation of coupling portion 42. Coupling portion 42 is configured to be coupled to torque coupling portion 44 such that rotation of torque coupling portion 44 about axis 52 also results in rotation of coupling portion 42 and swing arm 36. In one particular embodiment, coupling portion 42 may include castellations or teeth configured to intermesh and mate with corresponding castellations or teeth of torque coupling portion 44. In another embodiment, portion 42 may include one of a male projection or a female detent configured to receive the other of a male projection or a female detent of torque coupling portion 44. In still other embodiments, coupling portion 42 may have a sufficiently rough surface so as to couple with torque coupling portion 44 based on friction such that rotation of torque coupling portion 44 results in rotation of coupling portion 42 and swing arm 36.

Torque coupling portion 44 comprises a member configured to axially couple or connect to torque coupling portion 42 such that rotation of torque coupling portion 44 also rotates coupling portion 42. Torque coupling portion 44 is non-rotatably coupled to shaft 32 such that rotation of shaft 32 also results in rotation of torque coupling portion 44. Torque coupling portion 44 is further configured to move along axis 52 and is resiliently biased in a direction along axis 52 towards coupling portion 42. Torque coupling portion 44 facilitates the selective connection of coupling portion 42 and swing arm 36 to shaft 32 so as to rotate swing arm 36 and coupling gear 38 about axis 52 between various angular positions with respect to axis 52 at which torque may be transmitted to different recipients.

Bias 45 comprises a structure configured to resiliently bias or urge torque coupling portion 44 toward coupling portion 42 while limiting the extent to which torque coupling portion 44 is movable in a direction away from torque coupling portion 42. In one embodiment, bias 45 may comprise a compression spring axially retained along shaft 32 and in engagement with torque coupling portion 44. In other embodiments, bias 45 may comprise other mechanisms configured to resiliently urge torque coupling portion 44 towards torque coupling portion 42.

Linear actuator 46 comprises a device operably coupled to swing arm 36 and configured to linearly move swing arm 36, coupling gear 38 and torque coupling portion 42 along axis 52 in either of the directions indicated by arrows 61. In one embodiment, linear actuator 46 may constitute an electric solenoid. In other embodiments, linear actuator 46 may constitute other linear actuators such as hydraulic or pneumatic cylinder-piston assemblies, motor-driven rack gears or pulleys and the like.

Rotary actuator 48 comprises a source of torque or rotational motion operably coupled to shaft 32 to rotatably drive shaft 32. In one embodiment, rotary actuator 48 comprises a servomotor. In other embodiments, rotary actuator 48 may comprise other sources of torque.

Controller 50 comprises one or more processing units in communication with linear actuator 46 and rotary actuator 48 and configured to generate control signals for directing operation of linear actuator 46 and rotary actuator 48. For purposes of this disclosure, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 50 is not limited to any specific combination of hardware circuitry and software, nor to any particular source for the instructions executed by the processing unit.

FIGS. 1-3 illustrate transmission 20 being actuated from a first state in which torque from a source, such as rotary actuator 48, is being transmitted to a first recipient 22 (shown in FIG. 1) to a second state in which torque from the torque source is transmitted to a second recipient 26 (shown in FIG. 3). In the first state shown in FIG. 1, rotary actuator 48 supplies torque to rotatably drive shaft 32 and gear 34 about axis 52. Coupling gear 38 is in intermeshing engagement with gears 34 and 24 so as to transmit torque from gear 34 to gear 24. Gear 24 transmits such torque to recipient 22 for use by recipient 22.

FIG. 2 illustrates transmission 20 disengaging gear 24 to facilitate connection of transmission 20 to gear 28 to supply torque to recipient 26. As shown in FIG. 2, controller 50 generates control signals directing linear actuator 46 to linearly move swing arm 36 along axis 52 in the direction indicated by arrow 70. Linear actuator 46 moves swing arm 36 a sufficient distance so as to disengage coupling gear 38 from gears 34 and 24, moving swing arm 26 to a position such that it may be rotated about axis 52.

Linear actuator 46 further moves swing arm 36 a sufficient distance so as to move coupling portion 42 into engagement with torque coupling portion 44. During such engagement, bias 45 urges torque coupling portion 44 along axis 52 towards coupling portion 42 while permitting torque coupling portion 44 to move against the bias in the direction indicated by arrow 70 in such circumstances where linear actuator 46 moves coupling portion 42 too great of a distance along axis 52 or should connecting portions of coupling portions 42 and 44, such as teeth or castellations, be in abutment with one another. In those circumstances where coupling portion 42 and torque coupling portion 44 have mating portions that are in non-mating abutment, subsequent rotation of shaft 32 and torque coupling portion 44 moves such mating portions into alignment and bias 45 urges torque coupling portion 44 into mating engagement with coupling portion 42. As a result, torque coupling portion 44 provides “play” for transmission 20, reducing the likelihood of damage to transmission 20 such as when linear actuator 46 moves coupling portion 42 too great a distance in the direction indicated by arrow 70 due to variable component sizes, environmental conditions and the like, or when mating portions of coupling portion 42 and torque coupling portion 44 are in non-torque transmitting abutment during initial engagement.

As indicated by arrow 72, once linear actuator 46 has moved swing arm 36 a predetermined distance along axis 52 towards torque coupling portion 44, controller 50 generates control signals directing rotary actuator 48 to rotate shaft 32 about axis 52 in the direction indicated by arrow 72. Because torque coupling portion 44 is non-rotatably coupled to shaft 32 and is in engagement with coupling portion 42, swing arm 36 is also rotated about axis 52 to reposition coupling gear 38 with respect to gear 24 and in substantial alignment with gear 28 associated with recipient 26 (shown in FIG. 3).

As shown by FIG. 3, once swing arm 36 has been rotated to position coupling gear 38 in alignment with gear 28, controller 50 generates control signals directing linear actuator 46 to linearly move swing arm 36 along axis 52 in the direction indicated by arrow 76 a predetermined distance sufficient to move coupling gear 38 into meshing engagement with gear 28. As a result, further torque supplied by rotary actuator 48 in response to signals from controller 50 is transmitted through shaft 32 and across gears 34, 38 and 28 to recipient 26. In a similar manner, the process illustrated in FIGS. 1-3 may be carried out to disengage coupling gear 38 from gear 28 and to rotate swing arm 36 to another angular position before once again linearly moving swing arm 36 along axis 52 to engage coupling gear 38 with another gear associated with yet another recipient of torque.

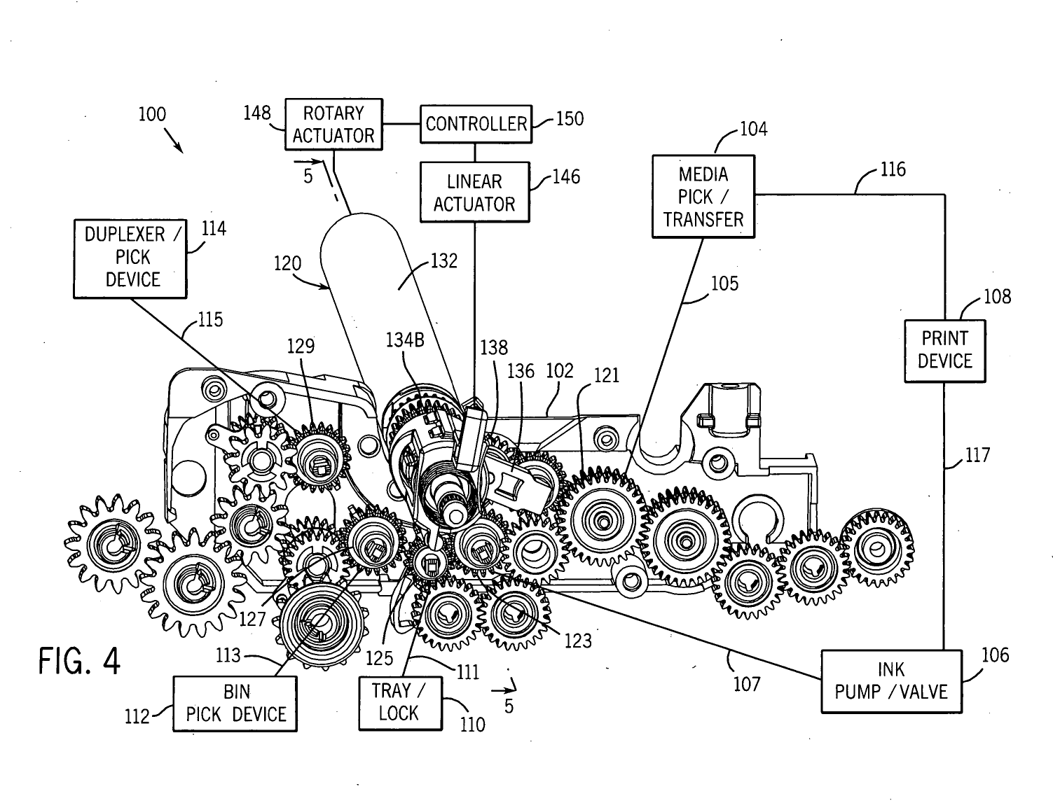

FIGS. 4-7 illustrate printer 100 including transmission 120, a particular embodiment of transmission 20 shown in FIGS. 1-3. In addition to transmission 120, printer 100 includes housing or frame 102, media pick/transfer 104, ink pump/valve 106, print device 108, tray/lock 110, bin pick device 112 and duplexer/pick device 114, all of which except for frame 102 are schematically shown. Frame 102 comprises one or more structures supporting each of the components of printer 100 and housing or enclosing at least some of the components of printer 100. Frame 102 may have a multitude of different configurations.

Media pick/transfer 104 comprises one potential recipient of torque that may be transmitted by transmission 120. As indicated by line 105, media pick/transfer 104 receives torque through a drive train including gear 121 which may be selectively operably connected to a torque source by transmission 120. Media pick/transfer includes a pick device configured to engage and pick a sheet of media from a tray, bin or other media storage receptacle associated with printer 100. In particular embodiments, media pick/transfer may additionally include one or more rollers, belts or other devices configured to transfer the picked sheet of media through printer 100 such as to print device 108 as indicated by line 116. In some embodiments, media pick/transfer may also be configured to transfer sheets of media to other components of printer 100 such as duplexer/pick device 114.

Ink pump/valve 106 comprises a potential recipient of torque that may be transmitted by transmission 120. As indicated by line 107, ink pump/valve 106 is configured to receive torque via a drive train including gear 123. In one embodiment, ink pump/valve 106 comprises a pump, such as peristaltic pump, configured to supply ink or other printing material to print device 108 as indicated by line 117. In yet another embodiment, ink pump/valve 106 may additionally or alternatively comprise a mechanism for opening and closing valves of an ink delivery system.

Print device 108 comprises a device configured to eject ink or other fluid printing material onto a medium to form a pattern or image upon the medium. In one embodiment, print device 108 may include one or more inkjet printheads. In one embodiment, print device 108 may eject ink received from an off-axis delivery system including ink pump/valve 106. In still other embodiments, ink pump/valve 106 may be omitted where print device 108 includes self-contained inkjet cartridges. In still other embodiments, print device 108 may comprise other devices configured to deposit or otherwise apply ink or other printing material to a medium.

Tray/lock 110 comprises another potential recipient of torque that may be transmitted by transmission 120. As indicated by line 111, tray/lock 110 receives torque through a drive train including gear 125. Gear 125 is configured to mesh with portions of transmission 20 to transmit torque to tray/lock 110. In one embodiment, tray/lock 110 comprises a movable tray and an associated linear drive mechanism such as a rack gear which utilizes torque to move the tray in and out of the printer body to position smaller sized media opposite a pick device. In particular embodiments, tray/lock 110 may additionally be configured to actuate between an unlocked position and a locked position, wherein the tray is immovable in the locked position. Tray/lock 110 is operably connected to print device 108 such that media picked from the tray may be transported to the print device 108 for printing. In particular embodiments, tray/lock 110 may be omitted.

Bin pick device 112 comprises yet another potential recipient of torque from transmission 120. As indicated by line 113, bin pick device 112 is configured to be operably connected to transmission 120 by a drive train including a gear 127. Gear 127 is configured to mesh with and be rotatably driven by portions of transmission 120. In the particular example illustrated, bin pick device 112 comprises a device configured to pick sheets of media from an auxiliary bin or tray. Torque transmitted to bin pick device 112 is utilized to rotatably drive a pick roller of the pick device. Picked sheets of media from the auxiliary bin (not shown) are transferred to print device 108 for printing. In other embodiments, bin pick device 112 may be omitted.

Duplexer/pick device 114 comprises yet another potential recipient of torque from transmission 120. As indicated by line 115, duplexer/pick device 114 is configured to be operably coupled to transmission 120 by a drive train including gear 129. Gear 129 is configured to mesh with and be rotatably driven by a portion of transmission 120. Torque received by duplexer/pick device 114 is utilized to drive one or more rollers or belts in engagement with sheets of media to duplex or overturn such media. The overturned media is subsequently transferred to print device 108 for printing. In yet other embodiments, torque received by duplexer/pick device 114 may additionally or alternatively be utilized to drive a pick device, such as a pick roller or tire, to pick a sheet of media from a tray or bin. In particular embodiments, duplexer/pick device 114 may be omitted.

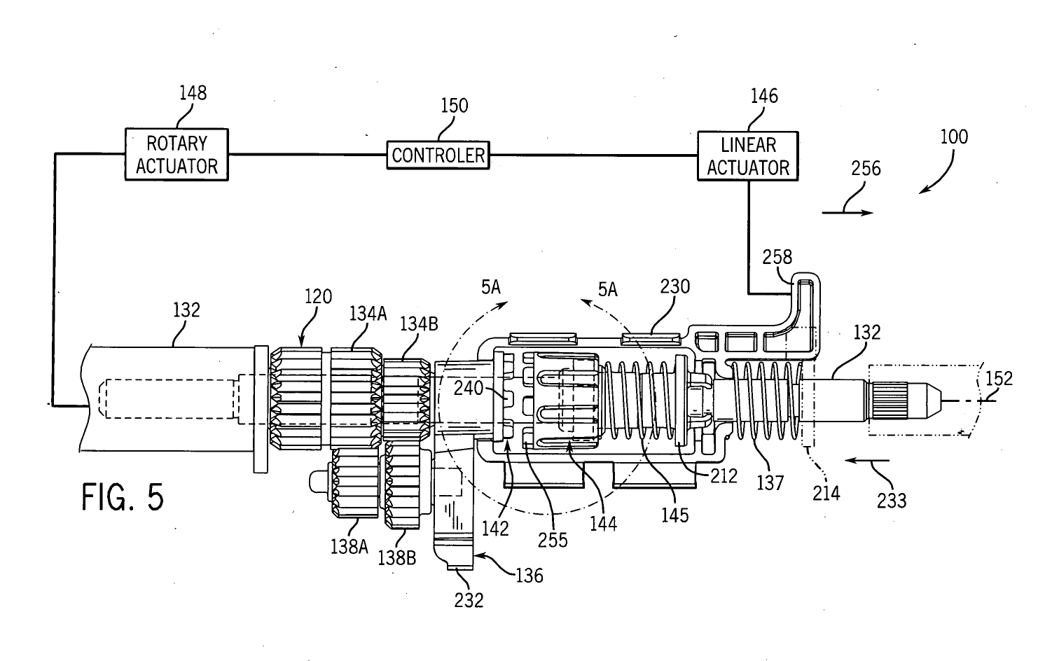

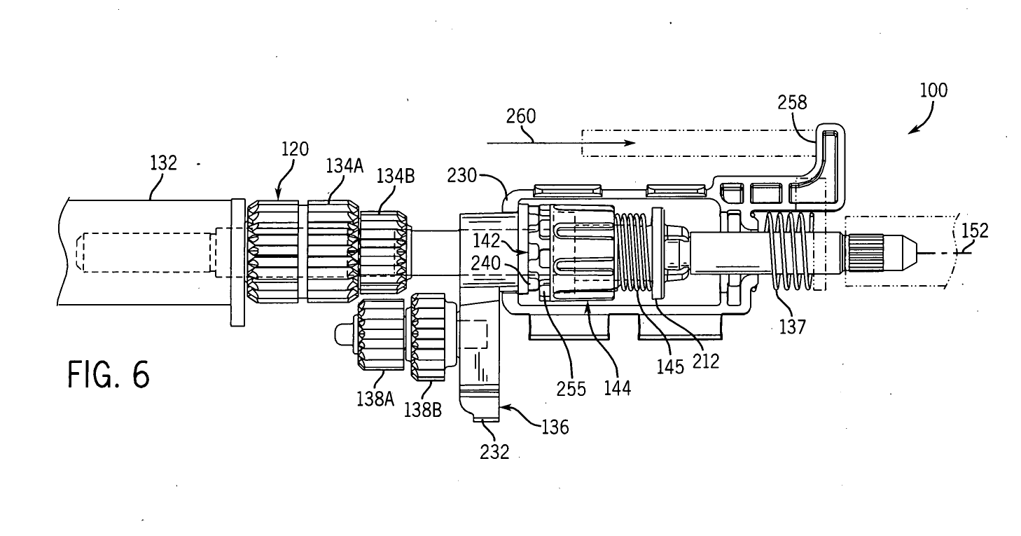

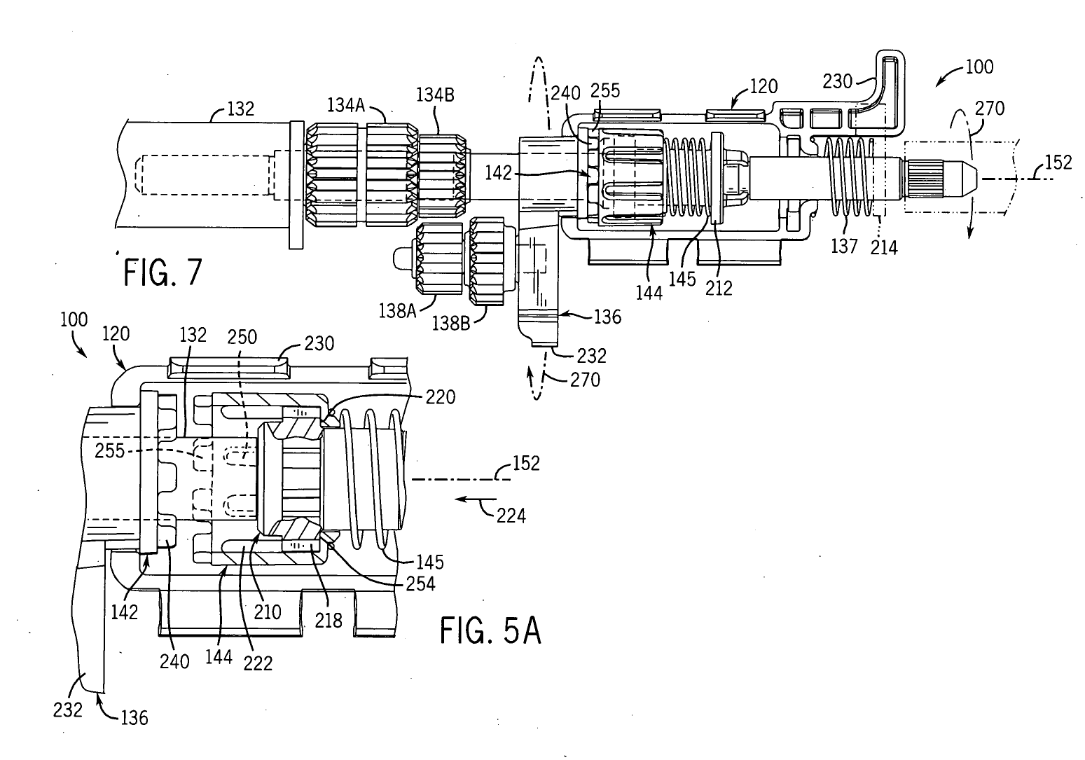

Transmission 120 selectively connects one of the potential torque recipients, media/pick transfer 104, ink pump/valve 106, tray/lock 110, bin pick device 112 or duplexer/pick device 114, to a source of torque to drive such components or devices. As shown by FIGS. 5 and 6, transmission 120 includes shaft 132, drive gears 134A, 134B (collectively referred to as drive gears 134), swing arm 136, swing arm return bias 137, coupling gears 138A, 138B (collectively referred to as coupling gears 138), coupling portion 142, torque coupling portion 144 (sometimes referred to as a synchronizer), bias 145, linear actuator 146, rotary actuator 148 and controller 150. Shaft 132 comprises an elongate shaft operably coupled to rotary actuator 148 so as to be rotatably driven by rotary actuator 148 in response to control signals from controller 150. Shaft 132 (sometimes referred to as a feed roller) extends along axis 152 and is non-rotatably coupled to drive gears 134 such that rotation of shaft 132 results in rotation of drive gears 134.

Shaft 132 includes anchor gear 210 (shown in FIG. 5A), retainer 212 and retainer 214. Anchor gear 210 comprises a structure configured to rotate about axis 152 with the rotation of shaft 132. Anchor gear 210 is further configured to non-rotatably couple torque coupling portion 144 to shaft 132 (i.e., inhibiting relative rotation between portion 144 and shaft 132) while permitting axial movement of torque coupling portion 144 along axis 152. In other words, upon rotation of shaft 132, anchor gear 210 transmits torque to torque coupling portion 144 such that torque coupling portion 144 also rotates with shaft 132. At the same time, however, anchor 210 permits torque coupling portion 144 to linearly move along axis 152.

In the particular embodiment illustrated in FIG. 5, anchor gear 210 comprises a distinct structure fixedly mounted upon the remainder of shaft 132. In other embodiments, anchor gear 210 may be integrally formed as a single unitary body with the remainder of shaft 132. Anchor 210 includes radially extending castellations or teeth 218 and shoulder 220. Castellations 218 mate or slide within corresponding grooves or channels 222 of torque coupling portion 144 to permit linear movement of torque coupling portion 44 while non-rotatably coupling torque coupling portion 144 to shaft 32. Shoulders 220 engage torque coupling portion 144 to limit linear movement of torque coupling portion 144 in the direction indicated by arrow 224 along axis 152. Although anchor gear 210 is illustrated as including a multitude of circumferentially spaced castellations 218, in other embodiments, anchor gear 210 may alternatively include other structures or configurations configured to engage shaft 132 and torque coupling portion 144 to one another to permit linear movement of torque coupling portion 144 while causing torque coupling portion 144 to rotate with the rotation of shaft 132.

Retainer 212 comprises a structure secured to a remainder of shaft 132 to axially retain one end of bias 137 while the other end of bias 137 bears against torque coupling portion 144. In the particular embodiment illustrated, retainer 212 comprises a member mounted, fixed, welded or bonded upon a remainder of shaft 132. In other embodiments, retainer 212 may be integrally formed as a single unitary body with shaft 132.

Retainer 214 comprises a structure axially secured to a remainder of shaft 132 and configured to axially retain an end of bias 137 while the other end of bias 137 bears against swing arm 136. In the embodiment illustrated, retainer 214 comprises a structure mounted or fastened to a remainder of shaft 132. In other embodiments, retainer 214 may alternatively be bonded, welded or integrally formed as a single unitary body with shaft 132. In still other embodiments, retainer 14, as well as retainer 212, may alternatively be associated with other structures other than shaft 132 while limiting axial movement of bias 145 and bias 137, respectively.

Drive gears 134 comprise pinion or spur gears non-rotatably coupled to shaft 132 so as to rotate with shaft 132. Gear 134A is configured to mesh with coupling gear 138A. Gear 134B is configured to mesh with coupling gear 138B. In other embodiments where swing arm 136 carries additional coupling gears 138, shaft 132 may also carry additional drive gears. In yet other embodiments, one or both of drive gears 134 may alternatively be rotatably mounted to shaft 132 so as to rotate relative to shaft 132, wherein such gears 134 are operably coupled to a source of torque other than rotary actuator 148. For example, in one embodiment, drive gear 134A may be configured to free-wheel or rotate with respect to shaft 132 and may be in meshing engagement with yet another gear (not shown) that receives torque from another torque source.

Swing arm 136 comprises one or more structures configured to linearly move along axis 152 in response to forces from linear actuator 146 while permitting shaft 132 to rotate about axis 152 with respect to swing arm 136 when coupling portion 142 and torque coupling portion 144 are disengaged. Swing arm 136 moves along axis 152 between an engaged position shown in FIG. 5 in which coupling gears 138 are in engagement with drive gears 134 and a retracted, disengaged position in which coupling gears 138 are out of engagement with drive gears 134 as shown in FIG. 6. Swing arm 136 is further configured to rotate about axis 152 when coupling portion 142 and torque coupling portion 144 are engaged. Swing arm 136 carries and rotatably supports coupling gears 138 such that coupling gears 138 may be also linearly moved along axis 152 to engage or disengage drive gears 134, to be rotated to a desired angular position in alignment with one of torque recipient gears 121, 123, 125 and 129, and to be linearly moved into engagement with torque recipient gears such as gears 121, 123, 125, 127 and 129 shown in FIG. 4.

In the particular example illustrated, swing arm 136 generally includes leash 230 and arm 232. Leash 230 comprises a structure extending about shaft 132 in axial sliding engagement with shaft 132 to guide linear movement of swing arm 136 along axis 152. Leash 230 is configured to receive force from linear actuator 146 to facilitate movement of swing arm 136 along axis 152. Leash 230 further supports arm 232. Although leash 230 is, illustrated as a largely cylindrical structure substantially surrounding torque coupling portion 144, in other embodiments, leash 230 may have a variety of other configurations.

Arm 232 comprises a structure extending from leash 230 and rotatably supporting coupling gears 138. Although swing arm 136 is illustrated as including a single arm 232, in other embodiments, swing arm 136 may include more than one arm 232 supporting additional coupling gears 138. Although swing arm 136 is illustrated as including arm 232, in other embodiments, swing arm 136 may include structures encircling axis 152, such as a disk, supporting one or more coupling gears 138.

Bias 137 comprises a device configured to resiliently bias swing arm 136 along axis 152 in the direction indicated by arrow 233 as seen in FIG. 5. In the particular embodiment illustrated, bias 137 comprises a compression spring axially captured between retainer 214 and leash 230. Bias 137 returns swing arm 136 and coupling gears 138 supported by swing arm 136 to their engaged positions shown in FIG. 5 upon cessation or reduction of force being applied to leash 230 by linear actuator 146. In other embodiments, bias 137 may comprise other structures configured to resiliently bias swing arm 136 and coupling gears 138 to their engaged positions. In yet other embodiments, bias 137 may be omitted where linear actuator 146 is configured to also move swing arm 136 in the direction indicated by arrow 233 to move swing arm 136 and coupling gears 138 to their engaged positions.

Coupling gears 138 constitute pinion or spur gears rotatably supported by arm 232 of swing arm 136 and configured to mesh with drive gears 134. Coupling gears 138 are further configured to mesh with gears associated with potential recipients of torque such as gears 121, 123, 125, 127 and 129 shown in FIG. 4. In the particular example illustrated in FIG. 5, transmission 120 includes two coupling gears 138a and 138b. As a result, torque may be simultaneously transmitted to two torque recipients through two separate drive trains while swing arm 136 and coupling gears 138 are at a single angular position with respect to axis 152. In particular, torque may be transmitted from drive gear 134A to a first drive train in meshing engagement with coupling gear 138A while torque may also be transmitted by drive gear 134B to a second drive train in meshing engagement with coupling gear 138B. In other embodiments, transmission 120 may alternatively include a single coupling gear 138 or more than two coupling gears 138.

Coupling portion 142 comprises a structure non-rotatably coupled to swing arm 136 such that rotation of coupling portion 142 results in rotation of swing arm 136. In the particular example illustrated, coupling portion 142 is integrally formed as a single unitary body with swing arm 136 and includes axially extending castellations 240 configured to mate with torque coupling portion 144 such that rotation of torque coupling portion 144 results in rotation of coupling portion 142 as well as swing arm 136. In other embodiments, coupling portion 142 may be mounted, fastened, welded, bonded or otherwise fixedly coupled to swing arm 136. In other embodiments, coupling portion 142 may be linearly movable along axis 152 with respect to swing arm 136. For example, in one embodiment, coupling portion 142 may be configured in a similar manner as to torque coupling portion 144 in that coupling portion 142 is non-rotatably coupled or connected to swing arm 136 while being linearly movable along axis 152 and resiliently biased towards torque coupling portion 144. Although coupling portion 142 is illustrated as including castellations 240 substantially uniformly circumferentially spaced about axis 152, in other embodiments, coupling portion 142 may alternatively include other structures configured to mate with torque coupling portion 144 upon axial movement of swing arm 136 and coupling portion 142 into engagement with torque coupling portion 144.

Torque coupling portion 144 comprises one or more members configured to be linearly movable along shaft 132 while being non-rotatably coupled to shaft 132 so as to rotate with shaft 132 about axis 152. In one particular embodiment, torque coupling portion 144 is configured to linearly move along axis 152 a distance of at least about 3 mm and up to about 9 mm. In one particular embodiment, torque coupling portion 144 is configured to linearly move along axis 152 a distance of about 8 mm. Torque coupling portion 144 is further configured to engage coupling portion 142 so as to transmit torque from shaft 132 to coupling portion 142 and swing arm 136 such that swing arm 136 also rotates about axis 152 with shaft 132 when torque coupling portion 144 is engaged with coupling portion 142.

As shown by FIG. 5A, in the particular example illustrated, torque coupling portion 144 comprises a cup-shaped member generally including internal circumferentially arranged castellations 250 which form channels 222, axially extending castellations 252 and shoulder 254. Castellations 250 extend along axis 152 within an interior of torque coupling portion 144 and form channels 222 which are configured to slidably receive castellations 218 of anchor gear 210. Castellations 250 cooperate with castellations 218 to permit slidable movement of torque coupling portion 144 along axis 152 relative to shaft 132. At the same time, castellations 250 and castellations 218 cooperate to connect torque coupling portion 144 and shaft 132 such that torque coupling portion 144 rotates with the rotation of shaft 132. In other embodiments, torque coupling portion 144 as well as anchor gear 210 may have other structures to facilitate sliding movement of torque coupling portion 144 along shaft 132 while non-rotatably coupling torque coupling portion 144 and shaft 132 to prevent substantial relative rotation of torque coupling portion 144 and shaft 132 about axis 152.

Castellations 255 comprise axially extending projections circumferentially spaced about axis 152 and configured to mate with castellations 240 of coupling portion 142 when torque coupling portion 144 and coupling portion 142 are engaged. Castellations 255 serve as a coupling portion coupled to torque coupling portion 144. When torque coupling portion 144 and coupling portion 142 are engaged, castellations 240 and 255 are configured such to cooperate with one another to transmit torque therebetween. In other embodiments, torque coupling portion 144 and coupling portion 142 may alternatively comprise other structures configured to facilitate transmission of torque between torque coupling portion 144 and coupling portion 142, wherein torque coupling portion 144 and coupling portion 142 are engaged. For example, in other embodiments, coupling portion 142 and torque coupling portion 144 may alternatively comprise intermeshing teeth or opposing surfaces of sufficient roughness so as to frictionally join to one another to transmit torque.

Shoulder 254 comprises a structure on the inside of torque coupling portion 144 configured to abut shoulder 220 of anchor gear 210. Shoulder 254 cooperates with shoulder 220 of anchor gear 210 to limit linear movement of torque coupling portion 144 in the direction indicated by arrow 224. In other embodiments, shoulder 220 may be omitted where other structures are utilized to limit linear movement of torque coupling portion 144.

Bias 145 comprises a device configured to resiliently bias torque coupling portion 144 along axis 152 in the direction indicated by arrow 224. When coupling portion 142 and swing arm 136 are out of engagement with torque coupling portion 144, bias 145 urges torque coupling portion 144 in the direction indicated by arrow 224 until shoulder 254 abuts shoulder 220. In the particular example illustrated, bias 145 comprises a compression spring axially captured between retainer 212 and leash 230 of swing arm 136. In other embodiments, bias 137 may comprise other structures or mechanisms configured to resiliently bias torque coupling portion 144 along axis 152 in the direction indicated by arrow 224.

Linear actuator 146 comprises a device configured to apply linear force to leash 230 of swing arm 136 in the direction indicated by arrow 256 so as to move swing arm 136 against bias 137 from the engaged position to the disengaged position. In embodiments where bias 137 is omitted, linear actuator 146 may also be configured to move swing arm 136 in the direction indicated by arrow 233 in FIG. 5 from the disengaged position to the engaged position. In one embodiment, linear actuator 146 comprises a servomotor mounted orthogonal to axis 152 and configured to drive a belt or pulley having a portion extending along axis 152 and carrying a hook or other projection configured to engage surface 258 of leash 230 of swing arm 136. In other embodiments, linear actuator 146 may comprise other electrical, mechanical, pneumatic or hydraulic linear actuators.

Rotary actuator 148 comprises a device operably coupled to shaft 132 so as to rotatably drive shaft 132 about axis 152. In the particular embodiment illustrated, rotary actuator 148 provides torque to rotate swing arm 136 and coupling gears 138 between various angular positions with respect to shaft 132 and into alignment with one of multiple gears associated with one of multiple torque recipients. In addition, rotary actuator 148 also provides the torque that is transmitted to such torque recipients via transmission 120 through shaft 132, drive gears 134 and coupling gears 138. In other embodiments, rotary actuator 148 may merely supply torque for rotating swing arm 136 where drive gears 134 are not rotated by shaft 132 and wherein a separate torque source is operably coupled to drive gears 134. In one particular embodiment, rotary actuator 148 comprises a DC motor having an encoder. In other embodiments, rotary actuator 148 may comprise other motors as well as other mechanisms configured to supply torque in two directions to shaft 132.

Controller 150 comprises one or more processing units configured to generate control signals directing operation of linear actuator 146 and rotary actuator 148. FIGS. 5-7 illustrate controller 150 generating control signals to actuate of transmission 120 from a first state in which torque is transmitted to a first torque recipient, such as media/pick transfer 104, ink pump/valve 106, tray/lock 110, bin pick device 112, duplexer/pick device 114 or other torque recipients, to a second state in which torque from the same torque source is transmitted to a second torque recipient. FIG. 5 illustrates transmission 120 in the first state. In particular, torque from rotary actuator 148 drives shaft 132. One or more of drive gears 134 transmit torque from shaft 132 to the gear of the drive train connected to the first torque recipient through coupling gears 138. For example, in one angular position, coupling gear 138A or coupling gear 138B may be in meshing engagement with gear 123 of the drive train connected to ink pump/valve 106. As a result, torque is transmitted through drive gear 134A and coupling gear 138A to gear 123 and ultimately to ink pump/valve 106. In the state shown in FIG. 5, swing arm 136 and coupling portion 142 are disengaged from torque coupling portion 144.

FIG. 6 illustrates linear actuator 146 applying force to leash 230 to move swing arm 136 in the direction indicated by arrow 260. As further shown by FIG. 6, such movement of swing arm 136 along axis 152 disengages coupling gears 138 from drive gears 134 and moves torque coupling portion 142 into engagement with torque coupling portion 144. In the particular example illustrated, castellations 240 of coupling portion 142 are in alignment with castellations 255 of coupling portion 244 when portions 142 and 252 are moved into engagement. As a result, the substantially flat ends of castellations 240 abut the substantially flat ends of castellations 255. However, because torque coupling portion 144 is linearly movable along axis 152, torque coupling portion 144 automatically adjusts its position along axis 152 to accommodate the alignment of castellations 240 and 255, reducing or eliminating damage to castellations 240 or 255, or other portions of transmission 120 or printer 100. Any impact forces transmitted to torque coupling portion 144 are absorbed by bias 145. As shown by FIG. 6, bias 145 compresses upon axial end-to-end abutment of castellations 240 and 255. In other embodiments in which torque coupling portions 142 and 252 include other inter-engaging portions less likely to abut one another in an undesirable fashion, such as when coupling portions 142 and 252 frictionally engage one another or include more tapered or pointed inter-engaging portions, torque coupling portion 144 also accommodates excess movement of swing arm 136 in the direction indicated by arrow 256 by linear actuator 146 that may occur due to manufacturing, operation and environmental variability.

FIG. 7 illustrates rotation of swing arm 136 to another angular position about axis 152, as indicated by arrows 270 to position coupling gears 138 in alignment with a gear of a drive train operably coupled to a second torque recipient, such as media pick/transfer 104, ink pump/valve 106, tray/lock 110, bin pick device 112, duplexer/pick device 114 or other torque recipients. In particular, in response to control signals from controller 150, rotary actuator 148 (shown in FIG. 5) supplies torque to rotate shaft 132 in the direction indicated by arrow 270. This results in torque coupling portion 144 also rotating about axis 152 relative to coupling portion 142 until castellations 240 and 255 move out of abutment so as to inter-mesh with one another as shown in FIG. 7. Thereafter, further rotation of gear 132 by rotary actuator 148 also rotates swing arm 136 to move coupling gears 138 to a desired angular position with respect to axis 152. Once coupling gears 138 have been rotated into alignment with a gear operably coupled to a second torque source, controller 150 generates control signals directing linear actuator 146 to retract in the direction indicated by arrow 233 in FIG. 5. As a result, bias 137 moves swing arm 136 along axis 152 in the direction indicated by arrow 233 until one or more of coupling gears 138 are linearly moved into engagement with the gear associated with the second torque recipient as well as drive gears 134. Transmission 120 is once again in the state shown in FIG. 5 but interconnecting rotary actuator 148 to a second torque recipient.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a shaft extending along an axis;
a swing arm carrying a first gear;
a first torque coupling portion carried by one of the shaft and the swing arm, wherein the swing arm is rotatable and is linearly movable along the axis; and
a second torque coupling portion non-rotatably coupled to the other of the shaft and the swing arm, wherein the second torque coupling portion is movable along the axis.

2. The apparatus of claim 1, wherein the first torque coupling portion is carried by the swing arm and wherein the second torque coupling portion is non-rotatably coupled to the shaft.

3. The apparatus of claim 1, wherein the first torque coupling portion and the second torque coupling portion include castellations.

4. The apparatus of claim 1, wherein the swing arm is axially slidable along the shaft.

5. The apparatus of claim 1, wherein the shaft extends through the swing arm.

6. The apparatus of claim 1 further comprising a second gear coupled to the shaft, wherein linear movement of the swing arm moves the first gear into and out of meshing engagement with the second gear.

7. The apparatus of claim 1 further comprising a second gear carried by the swing arm.

8. The apparatus of claim 7 further comprising:
a third gear configured and positioned to engage the first gear when the swing arm is in the first position; and
a fourth gear configured and positioned to engage the second gear when the swing arm is in the first position.

9. The apparatus of claim 7 further comprising a third gear coupled to the shaft and in meshing engagement with the second gear.

10. The apparatus of claim 1 further comprising a second gear configured and positioned to engage the first gear when the swing arm is in the first position.

11. The apparatus of claim 10, wherein the second gear is configured and positioned such that the second gear is out of engagement with the first gear when the swing arm is in the second position.

12. The apparatus of claim 10 further comprising a third gear configured and positioned to engage the first gear when the swing arm is in the second position.

13. The apparatus of claim 12, wherein the swing arm is configured to rotate to a third position and wherein the transmission further comprises a fourth gear configured and positioned to engage the first gear when the swing arm is in the third position.

14. The apparatus of claim 1 further comprising a structure coupled to the swing arm such that the swing arm linearly moves with linear movement of the structure and wherein the structure permits the swing arm to rotate about the axis.

15. The apparatus of claim 14 further comprising an actuator coupled to the structure so as to linearly move the structure.

16. The apparatus of claim 1 further comprising a media pick device, wherein the first gear transmits torque to the media pick device when the swing arm is in the first position.

17. The apparatus of claim 1 further comprising a media tray drive, wherein the first gear is configured to transmit torque to the media tray drive when the swing arm is in the first position.

18. The apparatus of claim 1 further comprising a duplexer, wherein the first gear is configured to transmit torque to the duplexer when the swing arm is in the first position.

19. The apparatus of claim 1, wherein the second torque coupling portion is configured to linearly move along the axis a distance of at least 3 mm.

20. The apparatus of claim 1 including a spring about the axis resiliently biasing the second torque coupling portion.

21. A transmission comprising:
a shaft;
a swing arm carrying a first gear and linearly movable along an axis;
a first torque coupling portion coupled to the shaft;
a second torque coupling portion coupled to the swing arm; and
means for moving the first torque coupling portion and the second torque coupling portion along the axis while in engagement.

22. A method comprising:
resiliently biasing a first torque coupling portion in a first direction along an axis, wherein the first torque coupling portion is non-rotatably coupled to one of a shaft and a swing arm carrying a first gear;
linearly moving the swing arm to a first position along the axis in which the first torque coupling portion engages a second torque coupling portion coupled to the other of the swing arm and the shaft; and
linearly moving the swing arm along the axis from the first position to a second position to move the first torque coupling portion in a second opposite direction along the axis.

23. The method of claim 22, wherein the movement of the first torque coupling portion in the second direction is in response to abutting non-mating engagement of the first torque coupling portion and the second torque coupling portion.

24. The method of claim 22, wherein movement of the swing arm to the first position disengages the first gear from a second gear.

25. The method of claim 22 further comprising rotating the swing arm.

26. The method of claim 22 further comprising transmitting torque from a second gear to the first gear.

27. The method of claim 26 further comprising engaging a third gear with the first gear.

28. The method of claim 22, wherein the first torque coupling portion is non-rotatably coupled to the shaft.

29. The method of claim 22, wherein movement of the first torque coupling portion in the second direction is in response to end-to-end abutment of teeth of the first torque coupling portion and the second torque coupling portion.

30. A printer comprising:
a print device;
a first torque recipient;
a first gear operably coupled to the first torque recipient;
a second torque recipient;
a second gear operably coupled to the second torque recipient;
a shaft extending along an axis;
a rotary actuator configured to rotate the shaft;
a swing arm carrying a third gear;
a first torque coupling portion carried by one of the shaft and the swing arm, wherein the swing arm is rotatable about the axis and is linearly movable along the axis;
a second torque coupling portion non-rotatably coupled to the other of the shaft and the swing arm, wherein the second torque coupling portion is movable along the axis; and
a linear actuator configured to move the swing arm along the axis to move the first torque coupling portion and the second torque coupling portion into torque transmitting engagement, wherein the rotary actuator is configured to rotate the swing arm to align the third gear with either the first gear or the second gear when the first torque coupling portion and the second torque coupling portion are in torque transmitting engagement.
